(19) United States
(12) Patent Application Publication
(10) Pub. No.: US 2023/0134216 A1
(43) Pub. Date: May 4, 2023

(54) WHITE-BOX PROCESSING FOR ENCODING WITH LARGE INTEGER VALUES

(71) Applicant: ARRIS Enterprises LLC, Suwanee, GA (US)

(72) Inventor: Lex Aaron ANDERSON, Auckland (NZ)

(73) Assignee: ARRIS Enterprises LLC, Suwanee, GA (US)

(21) Appl. No.: 17/979,710

(22) Filed: Nov. 2, 2022

Related U.S. Application Data
(60) Provisional application No. 63/275,284, filed on Nov. 3, 2021.

(51) Int. Cl. H04L 9/06

(52) U.S. Cl. CPC H04L 9/0631; H04L 2209/16

(57) ABSTRACT

A method and apparatus for securely processing an input to generate an output according to one or more encoded secrets is disclosed. In one embodiment, the method comprises a set of secrets S composed of a plurality of secrets s₁, s₂,..., sₙ, generating a first data structure based on the random encoding of the first secret s₁, and performing a plurality of cryptographic operations according to the input and the encoded secrets s₂,..., sₙ to compute the output according to each secret in the white-box implementation, the white-box implementation having at least one further data structure operating on the randomly encoded of the secrets.

### CROSS-REFERENCE TO RELATED APPLICATIONS

The present application claims priority to U.S. Provisional App. No. 63/275,284 filed Nov. 3, 2021, the content of which is incorporated herein by reference in its entirety.

### BACKGROUND

### 1. Field

The present disclosure relates to systems and methods for performing cryptographic operations, and in particular to a system and method for securely processing inputs in order to generate outputs used in cryptographic processes such as encryption and decryption.

### 2. Description of the Related Art

The goal of much of cryptography is to allow dissemination of information in such a way that prevents disclosure to unauthorized entities. This goal has been met using cryptographic systems and protocols (such as the Advanced Encryption Standard (AES), Data Encryption Standard(DES) and Triple Data Encryption Standard (TDES), Rivest-Shamir-Adleman (RSA), Elliptic Curve Cryptography (ECC)).

In the systems implementing such cryptographic systems, it is assumed that the attacker only has access to the input and output of the algorithm performing the cryptographic operation, with the actual processing being performed invisibly in a “black box.” For such a model to comply, the black box must provide a secure processing environment. Active research in this domain includes improved and special purpose cryptographic systems (e.g., lightweight block ciphers, authentication schemes, homomorphic public key algorithms), and the cryptanalysis thereof.

While such systems are effective, they are still vulnerable to attack. For example, protocols may be deployed in the wrong context, badly implemented algorithms, or inappropriate parameters may introduce an entry point for attackers.

New cryptanalysis techniques that incorporate additional side-channel information that can be observed during the execution of a crypto algorithm; information such as execution timing, electromagnetic radiation, and power consumption. Mitigating such side channel attacks is a challenge since it is hard to de-correlate this side-channel information from operations on secret keys. Moreover, the platform often imposes size and performance requirements that make it hard to deploy protection techniques.

Further exacerbating the foregoing problems, more applications are being performed on open devices with general purpose processors (e.g. personal computers, laptops, tablets, and smartphones) instead of devices having secure processors.

In response to the foregoing problems, many systems use “white-box” techniques, in which it is assumed that the attacker has full access to the software implementation of a cryptographic algorithm: the binary is completely visible and alterable by the attacker; and the attacker has full control over the execution platform (CPU calls, memory registers, etc.). In such systems, the implementation itself is the sole line of defense.

White-box cryptography was first published by Chow et al. (Stanley Chow, Philip A. Eisen, Harold Johnson, and Paul C. van Oorschot. A white-box DES implementation for DRM applications. In Proceedings of the ACM Workshop on Security and Privacy in Digital Rights Management (DRM 2002), volume 2696 of Lecture Notes in Computer Science, pages 1-15. Springer, 2002, hereby incorporated by reference herein). The core idea of white-box cryptography is to mathematically alter a program so that the program directly operates on encrypted and encoded secrets without these ever being present in cleartext form. Since these secrets are never present in cleartext form, the attacker can have complete visibility and control of the application and still not be able to make use of or gain any value from them. White-boxes can be static or dynamic. Static white-boxes have fixed secrets that are hard-coded at build-time. Dynamic white-boxes (as illustrated) can receive encoded secrets at runtime.

Table-based white-box transformations compose random bijections with an application’s functions. These compositions are emitted as lookup-tables (LUTs) so as to conceal the underlying secrets and other state values in the white-box implementation.

Lookup-tables (LUTs) used in present-day white-box implementations impose a practical limit on word size of operations that can be protected. Typically this is in the order of 8 bit words, which is ideal for ciphers such as AES. However, ECC and RSA algorithms use very large integer operations. For example, ECC typically operates on 256 bit or higher integers, and RSA typically operates on 2048 bit or higher integers. To fully support white-box operations on these integers would either require prohibitively large memory to store the lookup-tables or would be impracticably slow.

### SUMMARY

To address the requirements described above, this document discloses a system and method for securely processing an input to generate an output according to one or more encoded secrets. In one embodiment, the method accepting an encoded secret s′ having n units s₁, s₂,..., sₙ, and performing, in a white box implementation, a plurality of cryptographic operations according to the input and the encoded secret units s₁, s₂,..., sₙ to compute the output, the cryptographic operations performed according to at least one data structure comprising at least one partially encoded lookup table. Another embodiment is evidenced by an apparatus for securely processing an input to generate an output according to one or more encoded secrets that comprises a processor and a memory communicatively coupled to the processor, the memory storing processor instructions including processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIGS. 1A and 1B are diagrams of a cryptographic system processing an input message to produce an output message;

FIG. 2 is a diagram illustrating a white-box compiler applying encodings to isOdd at build time

FIG. 3 is a diagram illustrating white-box implementations of the rotateRight and rotateLeft baselines encoded as lookup-tables wbRotateRight and wbRotateLeft respectively;

FIG. 4 is a diagram depicting exemplary operations that can be used to securely process an input in order to generate an output;

FIG. 5 is a diagram illustrating one embodiment of pseudocode for the computation of relation y = x^{s}mod m in a white-box implementation;

FIG. 6 is a diagram showing one embodiment of pseudocode for computing computes y = x mod m given x and m using a Barrett’s reduction algorithm;

FIG. 7 is a diagram illustrating one embodiment of pseudocode for performing an ECC point multiplication computation; and

FIG. 8 illustrates an exemplary computer system that could be used to implement processing elements of the geolocation system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### White-Box Cryptographic Systems

A white-box system operates by encoding data elements (such as secret keys) so that they cannot be recovered by an attacker in their cleartext form. A white-box implementation is generated with mathematically altered functions that operate directly on the encoded data elements without decoding them. This guarantees that the secrets remain encoded at all times, thus protecting the implementation against attackers with full access to and control of the execution environment. This is described, for example, in the Chow reference cited above.

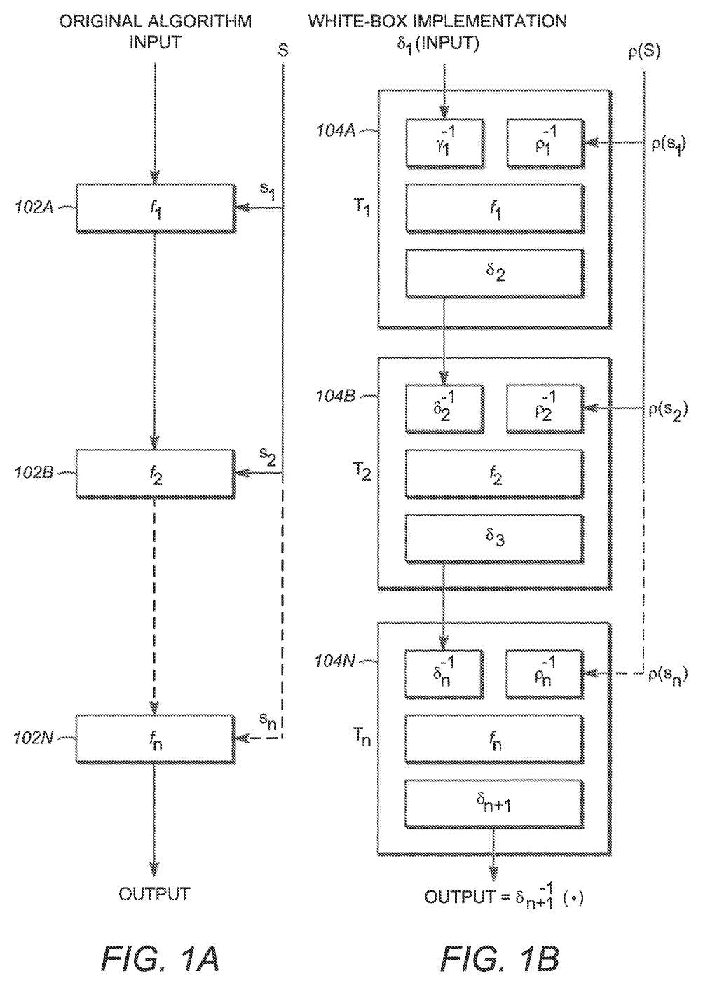

FIGS. 1A and 1B are diagrams of a cryptographic system processing an input message to produce an output message, and its corresponding white-box implementation.

As illustrated in FIG. 1A, the algorithm performs functions ƒ₁, ƒ₂ and ƒₙ (102A, 102B, and 102N, respectively) when provided with an input and secret S.

In FIG. 1B, each operation ƒ₁, ƒ₂, ..., ƒₙ in an original algorithm A(m, S) with input message m and secret S is encoded as a lookup-table T₁, T₂, ..., Tₙ (104A, 104B, and 104N, respectively) in the classical white-box implementation of that algorithm. The encodings are generated as two sequences of random bijections, δ₁, δ₂, ... , δₙ₊₁ that are applied to the inputs and output of each operation, where ρ(S) represents an encoded secret (e.g. a secret key), which is either linked statically or provided dynamically to the white-box implementation.

In the white-box implementation shown in FIG. 1B this is implemented by applying bijections δ₁ and ρ(S) as an input to lookup-table T₁ to obtain an intermediate output, applying the intermediate output and ρ(S) to lookup-table T₂ to produce a second intermediate output, then providing the second intermediate output and p(S) to lookup-table T₃ to produce output

$${δ}_{n + 1}^{- 1} \left(⋅\right) .$$

Lookup-table T₁ inverts the bijection δ₁ of the input by

$${δ}_{1}^{- 1} ,$$

inverts the bijection ρ of S (ρ(S)) by

$${ρ}_{1}^{- 1} ,$$

applies ƒ₁ and then applies bijection δ₂ to produce the first intermediate output. Similarly, lookup-table T₂ inverts the bijection δ₂ of the first intermediate input by

$${δ}_{2}^{- 1} ,$$

inverts the bijection ρ of S (ρ(S)) by

$${ρ}_{2}^{- 1} ,$$

applies ƒ₂ and then applies bijection δ₃ to produce the first intermediate output. Generally, final lookup-table Tₙ inverts the bijection δₙ of the n-1^{th} intermediate input by

$${δ}_{n}^{- 1} ,$$

inverts the bijection ρ of S (ρ(S)) by

$${ρ}_{n}^{- 1} ,$$

applies ƒₙ and then applies bijection δₙ₊₁ to produce the intermediate output

$${δ}_{n + 1}^{- 1} \left(⋅\right) .$$

### Overview

Disclosed herein are ECC and RSA key protection methods that are compatible with standard white-box encoding. These implementations are fast and secure against attackers limited to side-channel access of the implementation. The methods involve utilizing white-box operations that can be called directly from the algorithms in question to conceal the private keys.

White-box techniques are aimed at making key extraction difficult from cryptographic implementations. We present methods for protecting secret keys within the ECC and RSA algorithms, where the attacker has possession of the encoded secret key ρ(s) and is assumed to only have side-channel access to the implementation.

The private key s is stored as a list of permuted bytes. Since s is typically 1024-4096 bytes in length, it requires 128-512 bytes of storage. When making the white box program, a look up table with 256 entries (each entry is a byte) is first created. This table defines a permutation on bytes. Given the list of bytes representing s, we replace each byte by its result after applying the permutation. Hence, the stored value ρ(s) = (ρ(s₁), ρ(s₂), ..., ρ(sₙ)) wherein each sᵢ is a byte and ρ is the permutation. This list of bytes is then stored in the white-box program. The number of possible permutations is 256!, which is approximately 2¹⁶⁷⁸, which gives a high degree of security. Since the attacker does not know the lookup-table, the list of bytes appears to be completely random.

In one embodiment applicable to RSA cryptographic processes, for a private key s and modulus m, we wish to compute a RSA decryption of an encrypted message x, such that the decrypted message y = x^{s} mod m. The message x can include for example, a document, email message, key, secure data, or a portion media content such audiovisual information. In order to conceal the private key s, standard white-box encoding is used to compute an encoded key s′ = ρ(s). The encoded key s′ is used in place of s in untrusted environments. Since the original key s is uniformly random, and since ρ is a randomly chosen bijection, the encoded key s′ will also have a uniformly random distribution, meaning that recovering the secret key s from the encoded key s′ is computationally infeasible, providing that the bijection ρ is kept secret and is never sent outside of a secure network (there is no need to do this). To account for the encoding of the key, the RSA algorithm is modified to incorporate two white-box operations, wbIsOdd and pwbIsOdd.

The first operation is pwbIsOdd.The operation pwbIsOdd is a partially encoded white-box operation that returns 1 if an encoded byte is odd and 0 if an encoded byte is even. The second operation is wbRotateRight. The operation wbRotateRight is a fully encoded white-box operation that does a circular right bit shift of an encoded byte. This modified algorithm allows RSA to compute a decryption using an encoded private key s′ without directly decoding the bytes of s′ into cleartext.

In a second embodiment used in ECC with a white-box encoded private key, for a private key s and point P, we wish to compute an ECC point-multiplication operation Q = s · P. Computing the ECC point multiplication operations permits generation of decrypted information from encrypted information.

In order to conceal the private key s, standard white-box encoding is used to compute an encoded key s′ = ρ(s). The encoded key s′ is used in place of s in untrusted environments. Again, since the original key s is uniformly random, and since ρ is a randomly chosen bijection, the encoded key s′ will also have a uniformly random distribution, meaning that recovering the secret key s from the encoded key s′ is computationally infeasible, providing that the bijection ρ is kept secret and is never sent outside of a secure network (there is no need to do this).

The ECC point multiplication algorithm is modified to incorporate two white-box operations. The first such operation is pwbIsOdd.The pwbIsOdd operation is a partially encoded white-box operation that returns 1 if an encoded byte is odd and 0 if an encoded byte is even. The second such operation is wbRotateLeft. The wbRotateLeft operation is a fully encoded white-box operation that does a circular left bit shift of an encoded byte. Since the point multiplication algorithm is the only part of ECC that references the private key, this modified algorithm allows ECC to execute using an encoded private key s′, without directly decoding the bytes of s′ into cleartext.

### Lookup-Tables wbIsOdd and pwbIsOdd

If we let Pₑᵥₑₙ to be a randomly generated permutation of the set of even integers in the interval [0,2^{w-1}], and let P_{odd} be a randomly generated permutation of the set of odd integers in the interval [0,2^{w-1}]. Let T = {0,1}^{w} be a finite, non-empty alphabet, where w refers to the size (in bits) of the units of the encoded secret. For typical implementations, w = 8 corresponds to arrays of 8-bit words known as bytes. For ECC secret keys, typically n ≥ 32, and for RSA secret keys, typically n ≥ 256. The baseline lookup-table isOdd is defined as isOdd: T→ T as a zero indexed lookup-table of size 2w comprised of the interleaved permutations Pₑᵥₑₙ and P_{odd}, each of size 2w-1., such that for all x ∈ T that there exists a y ∈ T such that y = isOdd(x) is an odd number when x is odd and is an even number when x is even and Pr[isOdd(x) = x]_{x∈T} ≤ 2^{-w}. Multiple versions of isOdd may be generate by the white box compiler at build time for added diversity.

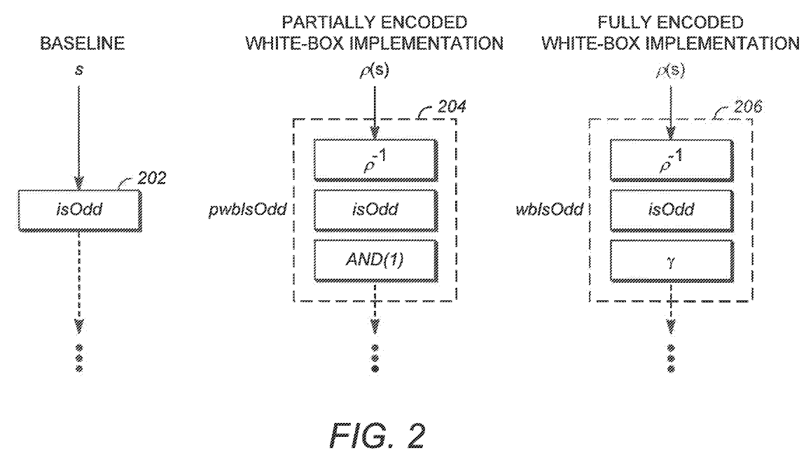

FIG. 2 is a diagram illustrating a white-box compiler applying encodings to isOdd at build time. The isOdd baseline 202 is encoded look up tables with random secret encodings ρ. The fully encoded table wbIsOdd lookup-table 206 has a random output bijection g generated by the white-box compiler at build time. The partially encoded table pwbIsOdd 204 instead applies a bitwise AND(1) operation to the output of isOdd, with AND: T→T, so that pwblsOdd returns an integer value of either 0 or 1 that can be used in non-white-box operations or conditional logic. With respect to the wbIsOdd lookup-table 206, the secret encoding ρ removes correlation between the secret s and the index in the encoded table. The output encoding g removes any correlation between the oddness of the encoded output and the oddness of the original values, hence the fully encoded lookup-table wbIsOdd gives an attacker no information about the value of any given input or output value. The partially encoded lookup-table pwblsOdd returns the oddness of the underlying encoded value, so that for all encoded inputs x ∈ T, there exists a y ∈ T such that

$$\begin{matrix}\text{y = pwbIsOdd} \left(\text{x}\right) = \text{AND} \left({\text{g}}^{- 1} \left(\text{wbIsOdd} \left(\text{x}\right)\right) , 1\right) = \\ \text{AND} \left(\text{isOdd} \left({ρ}^{- 1} \left(\text{x}\right)\right) , 1\right)\end{matrix}$$

In this scenario, the output value y is an integer truth value (0 or 1) that signifies the oddness of the underlying input ρ⁻¹(x). Due to the randomized implementation of the isOdd baseline, no other information about x is leaked when pwbIsOdd is used standalone. Omitting or undoing white-box encodings is not recommended, as it allows a white-box attacker to gain information about the underlying data. Furthermore, the use of conditional logic in a white-box implementation facilitates the use of side-channel attacks, which may further lower the attack difficulty. We do note however that these compromises may be deemed necessary for practical reasons.

### Lookup-Tables wbRotateRight and wbRotateLeft

We define the rotateRight and rotateLeft baselines as zero indexed lookup-tables each of size 2^{w} representing the binary right and left circular bit shift operations respectively, for all x = (x_{w-1}, x_{w-2}, ..., x₀)₂. as

$$\begin{matrix}r o t a t e R i g h t \left(\text{x}\right) : = \left({\text{x}}_{0} , {\text{x}}_{\text{w-1}} , … , {\text{x}}_{1}\right) 2 \\ r o t a t e L e f t \left(\text{x}\right) : = \left({\text{x}}_{\text{w-2}} , {\text{x}}_{\text{w-3}} , … . {\text{x}}_{\text{w-1}}\right) 2\end{matrix}$$

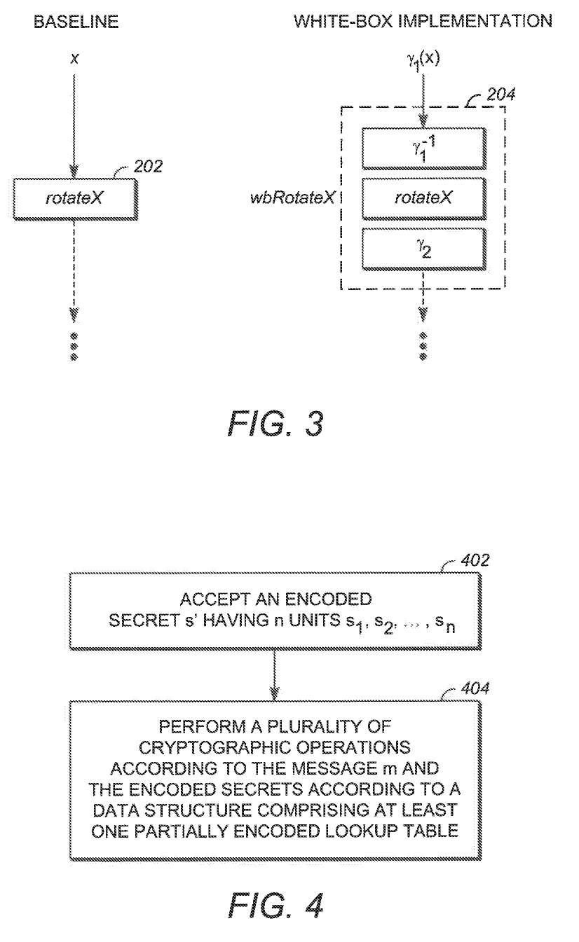

FIG. 3 is a diagram illustrating white-box implementations of the rotateRight and rotateLeft baselines encoded as lookup-tables wbRotateRight and wbRotateLeft respectively, with random bijections g₁, g₂ : T → T generated by a white-box compiler at build time.

The input encoding g₁ removes correlation between the input value x and the index in the encoded table. The output encoding g₂ removes any correlation between the rotated encoded output and the original rotated input, hence the encoded lookup-tables wbRoateRight and wbRotateLeft give an attacker no information about the value of any given input or output value.

Unlike pwbIsOdd, there is no reason to omit or undo the output encodings of these operations. However, it is noted that these operations, when used in conjunction with an implementation of pwblsOdd will enable an unconstrained white-box attacker to fully recover any protected values, simply by shifting w times in the same direction, setting the bits of a cloned value based on the output of pwbIsOdd.

FIG. 4 is a diagram depicting exemplary operations that can be used to securely process an input in order to generate an output according to an encoded secret s′ having n units s₁, s₂,..., sₙ,. In block 202, an encoded secret s′ having n units s₁, s₂, ..., sₙ, is accepted In one embodiment, encoded secrets s₁, s₂,..., sₙ are in units of bytes.

In step 404 a white-box implementation performs a plurality of cryptographic operations according to the message m and the encoded secrets s₁, s₂,..., sₙ. In one embodiment, this is performed according to at least one data structure comprising at least one partially encoded lookup table.

### RSA With White-Box Encoded Private Key

In a first embodiment, the plurality of cryptographic operations compute the output y according to a relation y = x^{s}mod m as applied an RSA decryption or encryption operation. In this embodiment, an iterative square and reduce algorithm may be used that includes determining if each bit of the encoded byte of the secret s is odd. For example, if the secret s comprises n bytes, and

$${{s}^{′}}_{i}$$

is the i^{th} byte of the secret s, the step of performing a plurality of cryptographic operations according to the message m and the encoded secrets comprises generating a first further data structure

$$p w b I s O d d \left({{s}^{′}}_{i}\right)$$

as a partially encoded lookup-table that applies a bitwise AND function to an output of an

$$I s O d d \left({{s}^{′}}_{i}\right)$$

lookup-table generated according to the random permutation, and generating a second further data structure

$$w b R o t a t e R i g h t \left({{s}^{′}}_{i}\right)$$

comprising an encoded lookup-table having random bijections of a circular bit shift operation.

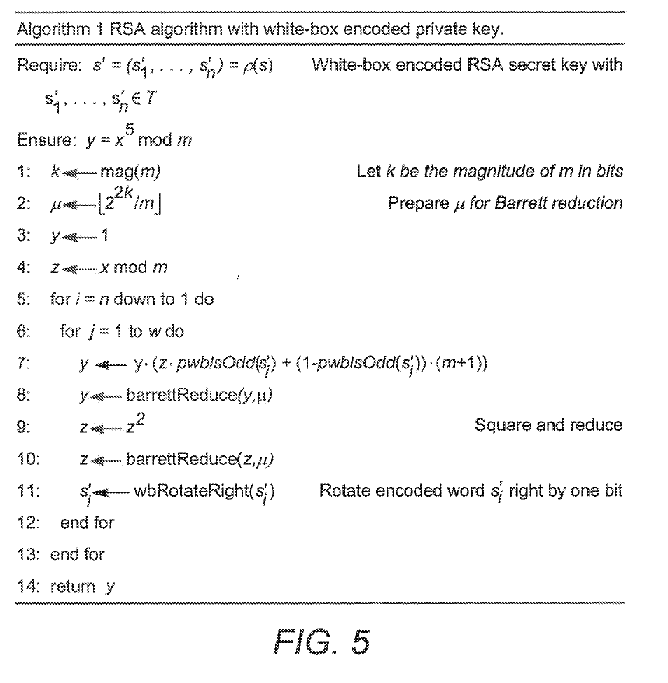

FIG. 5 is a diagram illustrating one embodiment of pseudocode for the computation of relation y = x^{s}mod m in a white-box implementation using the

$$p w b I s O d d \left({{s}^{′}}_{i}\right) , I s O d d \left({{s}^{′}}_{i}\right) ,$$

and

$$w b R o t a t e R i g h t \left({{s}^{′}}_{i}\right)$$

data structures. As indicated, an input is provided to the white-box implementation such that a white-box encoded RSA secret key

$${s}^{′} = \left({{s}^{′}}_{1} , … , {{s}^{′}}_{n}\right) = ρ \left(s\right)$$

is generated from the RSA secret key s. The white-box encoded RSA secret key

$${{s}^{′}}_{1} , … , {{s}^{′}}_{n} ∈ T .$$

In line 1, we define k is set to the magnitude of m in bits. In line, we define the variable m according to

$$\left⌊\frac{{2}^{2 k}}{m}\right⌋ , \text{where} \left⌊\right⌋$$

denotes a floor function. In line 3, factor y is initialized to 1, and in line 4, factor z is set to x mod m. Internal do loop performs the operations of lines 6-12, for each bit of the i^{th} byte of the secret s. These operations include computing y ← y.

$$\left(z - p w b I s O d d \left({{s}^{′}}_{i}\right) + 1 - p w b I s O d d \left({{s}^{′}}_{i}\right) ⋅ \left(m + 1\right)\right)$$

as shown in line 7, computing y ← barrettReduce(y, µ) as shown in line 8, computing z ← z² as shown in line 9, computing y ← barrettReduce(z, µ) as shown in line 10, and computing

$${s}_{i}^{i} ← w b R o t a t e R i g h t \left({s}_{i}^{'}\right) ,$$

as shown in line 11. External do loop of lines 5-13 repeats the operations of lines 6-12 for each i^{th} byte of the n bytes of the encoded secret s′. Line 14 returns the result y.

The Barrett’s reduction algorithm computes y = x mod m given x and m. The algorithm requires the precomputation of the quantity m according to

$$\left⌊\frac{{b}^{2 k}}{m}\right⌋ ,$$

and is advantageous if many reductions are performed with a single modulus. For example, each RSA encryption/decryption for one entity requires reduction modulo to that entity’s public key modulus. The precomputation takes a fixed amount of work, which is negligible to the cost of modular exponentiation. Typically, the radix b is chosen to be close to the words size of the processor (in our case, 2).

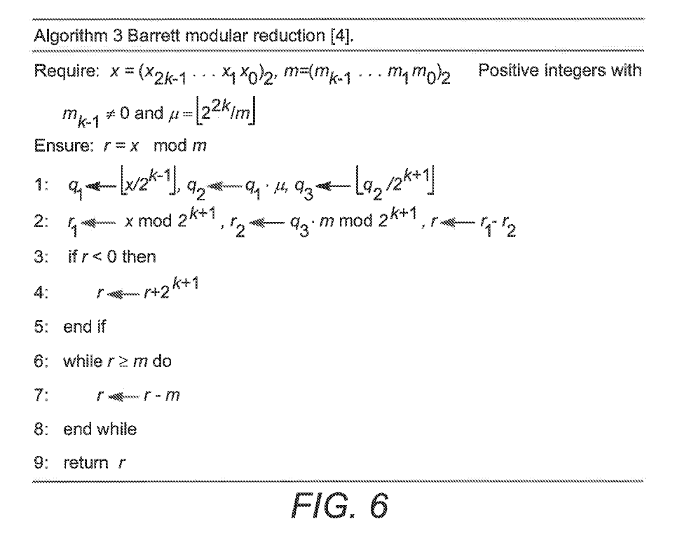

FIG. 6 is a diagram showing one embodiment of pseudocode for computing computes y = x mod m given x and m using a Barrett’s reduction algorithm. It assumes that x= (x₂ₖ₋₁ ... x₁x₀)₂ and m = (mₖ₋₁ ... m₁m₀)₂ are positive integers such that

$${\text{m}}_{k - 1} \neq 0 \text{and} μ \text{=} \left⌊\frac{{b}^{2 k}}{m}\right⌋ .$$

Steps 1-8 compute the value r = x mod m.

### Computation of an ECC Point Multiplication

In a second embodiment, the plurality of cryptographic operations together perform an ECC point multiplication operation that computes an output according to Q = s • P, where s is the secret, P is the input (a first point on the elliptic curve), and Q is the output (a second point on the elliptic curve).

Elliptic-Curve Cryptography (ECC) is an approach to public-key cryptography based on the algebraic structure of elliptic curves over finite fields. ECC is capable of using smaller keys than other forms of public key cryptography for the same level of security, thus providing the designer with a system providing a selectable combination of greater security or smaller keys. ECC has application in key agreements, digital signatures, pseudo-random generators, as well as other cryptographic tasks.

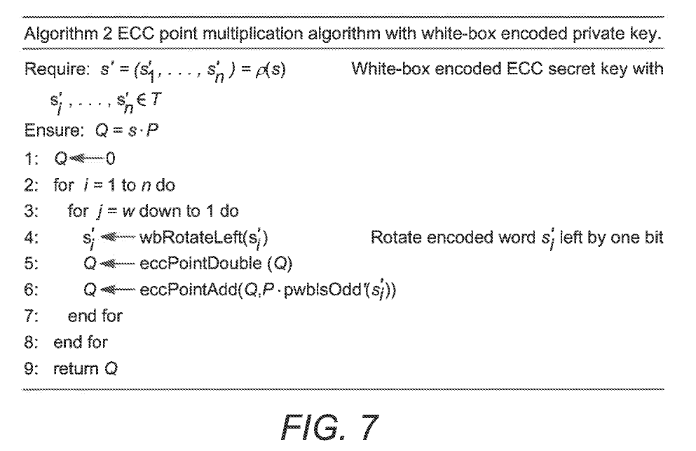

FIG. 7 is a diagram illustrating one embodiment of pseudocode for performing this computation. As indicated, an input is provided to the white-box implementation such that a white-box encoded ECC secret key

$$s ' = \left({s}_{1}^{'} , … , {s}_{n}^{'}\right) = ρ \left(s\right)$$

is generated from the ECC secret key s. The white-box encoded ECC secret key

$${s}_{1}^{'} , … , {s}_{n}^{'} ∈ T .$$

Lines 1-8 compute Q = s • P.

In line 1, we initialize Q to zero. The do loop illustrated in lines 3-7 computes the operations for lines 5-6 for each bit in the i^{th} byte of the encoded secret s′. Line 4 computes

$${s}_{i}^{'} ←$$

$$w b R o t a t e L e f t \left({s}_{i}^{'}\right) ,$$

which rotates the encoded word

$${s}_{i}^{'}$$

left by one bit. Line 5 computes Q eccPointDouble(Q), and line 6 computes

$$Q ← e c c P o i n t A d d \left(Q , p w b I s O d d ' \left({s}_{i} '\right)\right) .$$

Do loop encompassed in lines 2-8 are performs the aforementioned do lop for i = 1 to n, where n is the number of bytes in the secret s, and

$${{s}^{′}}_{i}$$

is the i^{th} byte of the encoded secret s. The result is the value of Q.

### Hardware Environment

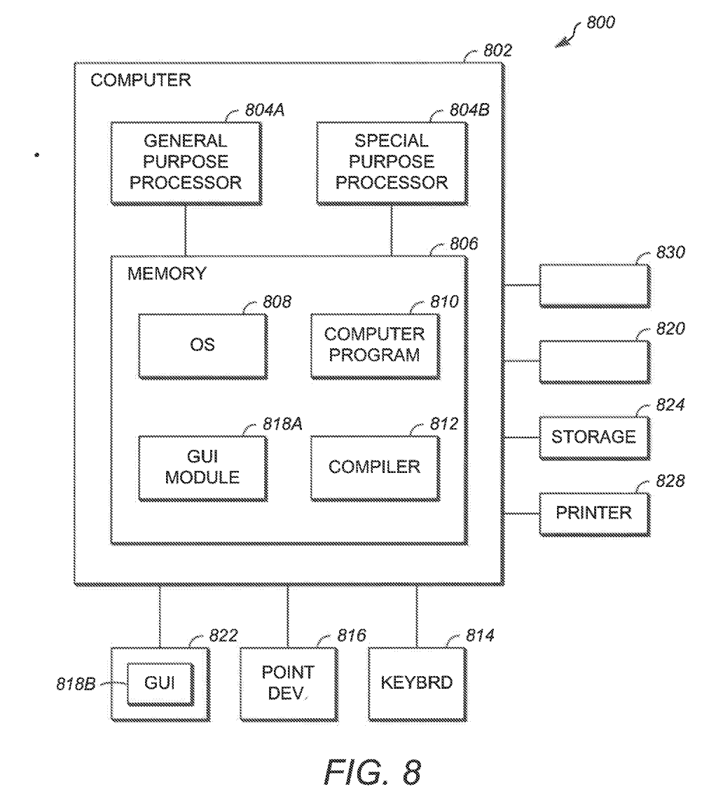

FIG. 8 illustrates an exemplary computer system 800 that could be used to implement processing elements of the above disclosure, including an encryptor or decryptor of messages or data. The computer 802 comprises a processor 804 and a memory, such as random access memory (RAM) 806. The computer 802 is operatively coupled to a display 822, which presents images such as windows to the user on a graphical user interface 818B. The computer 802 may be coupled to other devices, such as a keyboard 814, a mouse device 816, a printer 828, etc. Of course, those skilled in the art will recognize that any combination of the above components, or any number of different components, peripherals, and other devices, may be used with the computer 802.

Generally, the computer 802 operates under control of an operating system 808 stored in the memory 806, and interfaces with the user to accept inputs and commands and to present results through a graphical user interface (GUI) module 818A. Although the GUI module 818B is depicted as a separate module, the instructions performing the GUI functions can be resident or distributed in the operating system 808, the computer program 810, or implemented with special purpose memory and processors. The computer 802 also implements a compiler 812 which allows an application program 810 written in a programming language such as COBOL, C++, FORTRAN, or other language to be translated into processor 804 readable code. After completion, the application 810 accesses and manipulates data stored in the memory 806 of the computer 802 using the relationships and logic that was generated using the compiler 812. The computer 802 also optionally comprises an external communication device such as a modem, satellite link, Ethernet card, or other device for communicating with other computers.

In one embodiment, instructions implementing the operating system 808, the computer program 810, and the compiler 812 are tangibly embodied in a computer-readable medium, e.g., data storage device 820, which could include one or more fixed or removable data storage devices, such as a zip drive, floppy disc drive 824, hard drive, CD-ROM drive, tape drive, etc. Further, the operating system 808 and the computer program 810 are comprised of instructions which, when read and executed by the computer 802, causes the computer 802 to perform the operations herein described. Computer program 810 and/or operating instructions may also be tangibly embodied in memory 806 and/or data communications devices 830, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

The foregoing discloses a method, apparatus and system for securely processing an input m to generate an output. One embodiment is embodied in a method comprising accepting an encoded secret s′ having n units s₁, s₂,..., sₙ, and performing, in a white box implementation, a plurality of cryptographic operations according to the input and the encoded secret units s₁, s₂,..., sₙ to compute the output, the cryptographic operations performed according to at least one data structure comprising at least one partially encoded lookup table.

Implementations may include one or more of the following features:

Any of the methods above, wherein the encoded secret units s₁, s₂,..., sₙ are in units of bytes.

Any of the methods above, wherein the encoded secret s′ is randomly encoded by random permutations.

Any of the methods above, wherein the plurality of cryptographic operations together compute the output according to y = x^{s}mod m, wherein m is the input and y is the output.

Any of the methods above, wherein y = x^{s}mod m is computed according to an iterative square and reduce process that includes determining if each bit of each encoded byte of the encoded secret s′ is odd.

Any of the methods above, wherein the encoded secret s′ comprises n bytes;

$${{s}^{′}}_{i}$$

is an i^{th} byte of the encoded secret s′; performing, in the white box implementation, the plurality of cryptographic operations according to the input and the encoded secret units s₁, s₂,..., sₙ to compute the output comprises generating a first data structure

$$p w b I s O d d \left({{s}^{′}}_{i}\right)$$

as the partially encoded look-up table that applies a bitwise AND function to an output of an

$$I s O d d \left({{s}^{′}}_{i}\right)$$

look-up table generated according to a random permutation to return the oddness of an underlying encoded value, generating a second data structure

$$w b R o t a t e R i g h t \left({{s}^{′}}_{i}\right)$$

comprising an encoded look-up table having random bijections of a right circular bit shift operation; and the iterative square and reduce process comprises setting k ← mag(m) where k is a magnitude of m, setting

$$μ ← \left⌊\frac{{2}^{{2}^{k}}}{m}\right⌋ , \text{where} \left⌊\right⌋$$

where denotes a floor function, setting z ← x mod m, setting y ← 1for each i^{th} byte of the n bytes of the encoded secret s′: for each bit in the i^{th} byte of the encoded secret s′ computing

$$y ← y ⋅ \left(z - p w b I s O d d \left({{s}^{′}}_{i}\right) + 1 -\right)$$

$$\left(p w b I s O d d \left({{s}^{′}}_{i}\right) ⋅ \left(m + 1\right)\right) ;$$

computing y ← barrettReduce(y, µ); setting z ← z²; setting y ← barrettReduce(z, µ), setting

$${s}_{i}^{i} ← w b R o t a t e R i g h t \left({{s}^{′}}_{i}\right) ;$$

wherein: barretReduce (τ, θ) is a Barrett Reduction computation of inputs τ and θ.

Any of the methods above, wherein the plurality of cryptographic operations together comprise an ECC point multiplication that computes the output according to Q= s•P wherein P is the input and Q is the output.

Any of the methods above, wherein: the encoded secret s′ comprises n bytes;

$${{s}^{′}}_{i}$$

is an i^{th} byte of the encoded secret s′; performing, in the white box implementation, the plurality of cryptographic operations according to the input and the encoded secret units s₁, s₂,..., sₙ to compute the output comprises: setting Q ← 0; for each i^{th} byte of the n bytes of the encoded secret s′: for each bit in the i^{th} byte of the encoded secret s′: computing

$${{s}^{′}}_{i} ← \text{wbRotateLeft} \left({{s}^{′}}_{i}\right) ;$$

computing Q ← eccPointDouble(Q); computing Q ← eccPointAdd

$$\left(Q , p w b I s O d {d}^{′} \left({{s}^{′}}_{i}\right)\right)$$

returning Q; wherein: wbRotateLeft denotes rotating j^{th} bit of the i^{th} byte of the encoded secret

$${{s}^{′}}_{i}$$

left by one bit;

$$w b R o t a t e L e f t \left({{s}^{′}}_{i}\right)$$

is an indexed look-up table representing a binary left circular bit shift; and eccPointDouble(Q) denotes computing the point of Q+Q.

Another embodiment is evidenced by an apparatus for securely processing an input m to generate an output. The apparatus comprises a processor and a memory, communicatively coupled to the processor, the memory storing processor instructions comprising processor instructions for accepting an encoded secret s′ having n units s₁, s₂,..., sₙ,, and performing, in a white box implementation, a plurality of cryptographic operations according to the input and the encoded secret units s₁, s₂,..., sₙ to compute the output, the cryptographic operations performed according to at least one data structure comprising at least one partially encoded lookup table.

Implementations may include one or more of the following features:

The apparatus described above, wherein the encoded secret units s₁, s₂,..., sₙ are in units of bytes.

Any apparatus described above, wherein the encoded secret s′ is randomly encoded by random permutations.

Any apparatus described above, wherein the plurality of cryptographic operations together compute the output according to y = x^{s}mod m, wherein m is the input and y is the output.

Any apparatus described above, wherein y = x^{s}mod m is computed according to an iterative square and reduce process that includes determining if each bit of each encoded byte of the encoded secret s′ is odd.

Any apparatus described above, wherein: the encoded secret s′ comprises n bytes;

$${{s}^{′}}_{i}$$

is an i^{th} byte of the encoded secret s′; performing a plurality of cryptographic operations according to the input and the encoded secret units s₁, s₂,..., sₙ comprises: generating a first data structure

$$p w b I s O d d \left({{s}^{′}}_{i}\right)$$

as the partially encoded look-up table that applies a bitwise AND function to an output of an IsOdd(si) look-up table generated according to a random permutation to return the oddness of an underlying encoded value; generating a second data structure

$$w b R o t a t e R i g h t \left({{s}^{′}}_{i}\right)$$

comprising an encoded look-up table having random bijections of a right circular bit shift operation; and the iterative square and reduce process comprises: setting k ← mag(m) where k is a magnitude of m; setting

$$μ ← \left⌊\frac{{2}^{{2}^{k}}}{m}\right⌋ , \text{where} \left⌊\right⌋$$

where denotes a floor function; setting z ← x mod m; setting y ← 1; for each i^{th} byte of the n bytes of the encoded secret s′: for each bit in the i^{th} byte of the encoded secret s′: computing

$$\text{computing} y ← y ⋅ \left(z - p w b I s O d d \left({{s}^{′}}_{i}\right) + 1 -\right)$$

$$p w b I s O d d \left({{s}^{′}}_{i}\right) ⋅ \left(m + \left(1\right)\right) ;$$

computing y ← barrettReduce(y, µ); setting z ← z²; setting y ← barrettReduce(z, µ); setting

$${s}_{i}^{i} ← w b R o t a t e R i g h t \left({{s}^{′}}_{i}\right) ;$$

wherein: barretReduce (τ, θ) is a Barrett Reduction computation of inputs τ and θ.

Any apparatus described above, wherein the plurality of cryptographic operations together comprise an ECC point multiplication that computes the output according to Q= s•P wherein P is the input and Q is the output.

Any apparatus described above, wherein: the encoded secret s′ comprises n bytes;

$${{s}^{′}}_{i}$$

is an i^{th} byte of the encoded secret s′; performing, in the white box implementation, the plurality of cryptographic operations according to the input and the encoded secret units s₁, s₂,..., sₙ to compute the output comprises: setting Q ← 0; for each i^{th} byte of the n bytes of the encoded secret s′: for each bit in the i^{th} byte of the encoded secret s′: computing

$${{\text{s}}^{′}}_{i} ← \text{wbRotateLeft} \left({{\text{s}}^{′}}_{i}\right) ;$$

computing Q ← eccPointDouble(Q); computing Q ← eccPointAdd

$$\left(Q , p w b I s O d {d}^{′} \left({{s}^{′}}_{i}\right)\right) ;$$

returning Q; wherein: wbRotateLeft denotes rotating j^{th} bit of the i^{th} byte of the encoded secret

$${{s}^{′}}_{i}$$

left by one bit; wbRotateLeft

$$\left({{s}^{′}}_{i}\right)$$

is an indexed look-up table representing a binary left circular bit shift; and eccPointDouble(Q) denotes computing the point of Q+Q.

### Conclusion

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of securely processing an input m to generate an output, comprising
accepting an encoded secret s′ having n units s₁, s₂,..., sₙ,; and
performing, in a white box implementation, a plurality of cryptographic operations according to the input and the encoded secret units s₁, s₂,..., sₙ to compute the output, the cryptographic operations performed according to at least one data structure comprising at least one partially encoded lookup table.

2. The method of claim 1, wherein the encoded secret units s₁, s₂,..., sₙ are in units of bytes.

3. The method of claim 2, wherein the encoded secret s′ is randomly encoded by random permutations.

4. The method of claim 3, wherein the plurality of cryptographic operations together compute the output according to y = x^{s} mod m, wherein m is the input and y is the output.

5. The method of claim 4, wherein y = x^{s} mod m is computed according to an iterative square and reduce process that includes determining if each bit of each encoded byte of the encoded secret s′ is odd.

6. The method of claim 5, wherein:
the encoded secret s′ comprises n bytes;
s′ᵢ is an i^{th} byte of the encoded secret s′;
performing, in the white box implementation, the plurality of cryptographic operations according to the input and the encoded secret units s₁, s₂,..., sₙ to compute the output comprises:
generating a first data structure pwblsOdd(s′i) as the partially encoded look-up table that applies a bitwise AND function to an output of an IsOdd(s′i) look-up table generated according to a random permutation to return the oddness of an underlying encoded value;
generating a second data structure wbRotateRight(s′ᵢ) comprising an encoded look-up table having random bijections of a right circular bit shift operation; and
the iterative square and reduce process comprises:
setting k ← mag(m) where k is a magnitude of m;
setting µ ← I ^{L22} / ₘ|, where [ ] denotes a floor function;
setting z ← x mod m;
setting y ← 1
for each i^{th} byte of the n bytes of the encoded secret s′:
for each bit in the i^{th} byte of the encoded secret s′:
computing y ← y ■ (z - pwbIsOdd(s′ᵢ) + 1 - pwbIsOdd(s′ᵢ) ■ (m + 1));
computing y ← barrettReduce(y,µ);
setting z ← z²;
setting y ← barrettReduce(z, µ);
setting si ← wbRotateRight(s′ᵢ); wherein:
barretReduce (τ, θ) is a Barrett Reduction computation of inputs τ and θ.

7. The method of claim 4, wherein the plurality of cryptographic operations together comprise an ECC point multiplication that computes the output according to Q= s•P wherein P is the input and Q is the output.

8. The method of claim 7, wherein:
the encoded secret s′ comprises n bytes;
s′ᵢ is an i^{th} byte of the encoded secret s′;
performing, in the white box implementation, the plurality of cryptographic operations according to the input and the encoded secret units s₁, s₂,..., sₙ to compute the output comprises:
setting Q ← 0;
for each i^{th} byte of the n bytes of the encoded secret s′:
for each bit in the i^{th} byte of the encoded secret s′:
computing s′ᵢ ← wbRotateLeft(s′ᵢ);
computing Q ← eccPointDouble(Q);
computing Q ← eccPointAdd (Q,pwbIsOdd′(s′ᵢ));
returning Q; wherein:
wbRotateLeft denotes rotating j^{th} bit of the i^{th} byte of the encoded secret s′ᵢ left by one bit;
wbRotateLeft(s′i) is an indexed look-up table representing a binary left circular bit shift; and
eccPointDouble(Q) denotes computing the point of Q+Q.

9. An apparatus for securely processing an input m to generate an output, comprising:
a processor;
a memory, communicatively coupled to the processor, the memory storing processor instructions comprising processor instructions for:
accepting an encoded secret s′ having n units s₁, s₂,..., sₙ,; and
performing, in a white box implementation, a plurality of cryptographic operations according to the input and the encoded secret units s₁, s₂,..., sₙ to compute the output, the cryptographic operations performed according to at least one data structure comprising at least one partially encoded lookup table.

10. The apparatus of claim 9, wherein the encoded secret units s₁, s₂,..., sₙ are in units of bytes.

11. The apparatus of claim 10, wherein the encoded secret s′ is randomly encoded by random permutations.

12. The apparatus of claim 11, wherein the plurality of cryptographic operations together compute the output according to y = x^{s} mod m, wherein m is the input and y is the output.

13. The apparatus of claim 12, wherein y = x^{s} mod m is computed according to an iterative square and reduce process that includes determining if each bit of each encoded byte of the encoded secret s′ is odd.

14. The apparatus of claim 13, wherein:
the encoded secret s′ comprises n bytes;
s′ᵢ is an i^{th} byte of the encoded secret s′;
performing a plurality of cryptographic operations according to the input and the encoded secret units s₁, s₂,..., sₙ comprises:
generating a first data structure pwbIsOdd(s′i) as the partially encoded look-up table that applies a bitwise AND function to an output of an IsOdd(s′i) look-up table generated according to a random permutation to return the oddness of an underlying encoded value;
generating a second data structure wbRotateRight(s′ᵢ) comprising an encoded look-up table having random bijections of a right circular bit shift operation; and
the iterative square and reduce process comprises:
setting k ← mag (m) where k is a magnitude of m;
setting µ ← ^{I} L²² ^{k}/ ₘ], where [ ] denotes a floor function ;
setting z ← x mod m;
setting y ← 1
for each i^{th} byte of the n bytes of the encoded secret s′:
for each bit in the i^{th} byte of the encoded secret s′:
computing y ← y ■ (z - pwbIsOdd(s′ᵢ) + 1 - pwbIsOdd(s′ᵢ) ■ (m + 1));
computing y ← barrettReduce(y, µ);
setting z ← z²;
setting y ← barrettReduce(z, µ);
setting si ← wbRotateRight(s′ᵢ); wherein:
barretReduce (τ, θ) is a Barrett Reduction computation of inputs τ and θ.

15. The apparatus of claim 12, wherein the plurality of cryptographic operations together comprise an ECC point multiplication that computes the output according to Q= s•P wherein P is the input and Q is the output.

16. The apparatus of claim 15, wherein:
the encoded secret s′ comprises n bytes;
s′ᵢ is an i^{th} byte of the encoded secret s′;
performing, in the white box implementation, the plurality of cryptographic operations according to the input and the encoded secret units s₁, s₂,..., sₙ to compute the output comprises:
setting Q ← 0;
for each i^{th} byte of the n bytes of the encoded secret s′:
for each bit in the i^{th} byte of the encoded secret s′:
computing s′ᵢ ← wbRotateLeft(s′i);
computing Q ← eccPointDouble(Q);
computing Q ← eccPointAdd (Q,pwbIsOdd′(s′ᵢ));
returning Q; wherein:
wbRotateLeft denotes rotating j^{th} bit of the i^{th} byte of the encoded secret s′ᵢ left by one bit;
wbRotateLeft(s′ᵢ) is an indexed look-up table representing a binary left circular bit shift; and
eccPointDouble(Q) denotes computing the point of Q+Q.

17. An apparatus for securely processing an input to generate an output, comprising means for accepting an encoded secret s′ having n units s₁, s₂,..., sₙ,; and
means for performing, in a white box implementation, a plurality of cryptographic operations according to the input and the encoded secret units s₁, s₂,..., sₙ to compute the output, the cryptographic operations performed according to at least one data structure comprising at least one partially encoded lookup table.

18. The apparatus of claim 17, wherein the encoded secrets s₁, s₂,..., sₙ are in units of bytes.

19. The apparatus of claim 18, wherein the encoded secret s′ is randomly encoded by random permutations.

20. The apparatus of claim 19, wherein the plurality of cryptographic operations together compute the output according to y = x^{s} mod m, wherein m is the input and y is the output.
